(19) United States
(12) Patent Application Publication
(10) Pub. No.: US 2011/0020669 A1
(43) Pub. Date: Jan. 27, 2011

(54) MAGNETIC RECORDING MEDIUM

(76) Inventors: Junichi SAYAMA, Fujisawa (JP); Hiroaki Nemoto, Odawara (JP); Hiroshi Ide, Tokyo (JP); Hiroyasu Kataoka, Sendai (JP); Nobuyukl Takahashi, Matsumoto (JP); Takehito Shimatsu, Natori (JP); Osamu Kitakami, Sendai (JP); Satoshi Okamoto, Sendai (JP); Hajime Aoi, Sendai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/840,374

(22) Filed: Jul. 21, 2010

(30) Foreign Application Priority Data
Jul. 24, 2009 (JP) 2009-173141

(51) Int. Cl. G11B 5/706; G11B 5/62; G11B 5/73

(52) U.S. Cl. 428/831; 428/836.1; 428/836.2

(57) ABSTRACT

A magnetic recording medium having excellent stability of recorded magnetic signals and capable of recording magnetic signals by a thermally assisted magnetic recording system in which a magnetic recording layer of the magnetic recording medium contains ferromagnetic crystal grains of a Co—Ni—Pt alloy with a Pt content of 44 at % or more and 55 at % or less and with an atom content ratio: Ni/(Co+Ni) of 0.64 or more and 0.8 or less. The magnetic recording medium has extremely excellent stability of recorded magnetic signals since the Co—Ni—Pt alloy constituting the magnetic recording layer has an extremely high anisotropy field at a normal temperature. Further, the magnetic recording medium can perform signal recording based on the thermally assisted magnetic recording system since the Co—Ni—Pt alloy constituting the magnetic recording layer has a Curie point within an appropriate temperature range.

### CLAIM OF PRIORITY

The present application claims priority from Japanese application serial No. 2009-173141, filed on Jul. 24, 2009, the content of which is hereby incorporated by reference into this application.

### BACKGROUND OF THE INVENTION

1. Field of the Invention

The present invention relates to a magnetic recording medium suitable for a thermally assisted magnetic recording system, which records a magnetic signal by applying an external magnetic field to the recording medium with the recording medium locally heated.

2. Description of the Related Art

In recent years, magnetic recording devices typically represented by hard disk drives have been mounted generally not only to personal computers or servers but also to household electric products and increase in the capacity thereof has been demanded strongly. Increase in the capacity of the magnetic recording device, that is, increase in recording density of a magnetic recording medium has been achieved so far through reduction in size of ferromagnetic crystal grains constituting a magnetic recording layer of a magnetic recording medium.

However, with reduction in size of ferromagnetic crystal grains, the magnetic anisotropic energy of the ferromagnetic crystal grain is decreased relatively to the thermal vibration energy of an atom and recorded magnetization cannot be maintained stably. This is a phenomenon called a thermal fluctuation of magnetization, which is a main factor that determines the physical limit in the recording density of the magnetic recording medium.

In order to suppress the thermal fluctuation of magnetization, it is indispensable that the magnetic recording layer of the magnetic recording medium comprises a material having an essentially high magnetic anisotropic energy. For example, in a magnetic recording medium at an areal recording density of more than 1.5 Tb/inch², it is necessary to use, as the magnetic recording layer, a material having an anisotropy field of 50 kOe or more at a normal temperature.

Co—Cr based alloys have mainly been used conventionally for materials for the magnetic recording layer of the magnetic recording medium, (for example, refer to JP-A-60-214417). However, it is impossible in principle in view of the origin of the magnetic anisotropy of the Co—Cr based alloys that Co—Cr based alloys develop a high anisotropy field of 50 kOe or more. Accordingly, in order to respond to the demand for higher recording density of the magnetic recording medium, it is necessary to develop a material having a higher anisotropy field than the Co—Cr based ally.

To solve the problem described above, alloys comprising a transition metal element and a noble metal element such as Co—Pt alloys have been proposed (for example, refer to JP-A-2002-216330, JP-A-2004-213869, and “Fabrication of L11 type Co—Pt ordered alloy films by sputter deposition”, by Sato H., and other 6 persons, in J. Appl. Phys., vol. 103, 07E114-1 to 07E114-3pp, 2008). In this case, the atom content is substantially equal between the transition metal element (Co) and the noble metal element (Pt). Since the alloys described above develop an anisotropy field as high as 50 kOe or more, they are suitable as materials for the magnetic recording layer of the magnetic recording media having a high recording density. JP-A-2002-216330 describes that a high anisotropy field is developed in a Co—Ni—Pt alloy in which the atom content is substantially equal between the transition metal element (Co) and the noble metal element (Pt), and the atom content for Ni is 0.1% or more and 50% or less. Further, it has been reported that a high anisotropy field is developed in a Co—Ni—Pt alloy in which the atom content is substantially equal between transition metal elements (Co and Ni) and a noble metal element (Pt) in “Fabrication of L11 type (Co—Ni)—Pt ordered alloy films by sputter deposition”, by Sato H., and other 5 persons, in J. Appl. Phys., vol. 105, 07B7 26-1 to 07B726-3pp, 2009.

In contrast, the strength of the magnetic field necessary for switching the magnetization in the magnetic recording medium is strongly dominated by the strength of the anisotropy field. Thus a magnetic recording medium having such a high anisotropy field as described above results in a problem that recording is impossible if a maximum magnetic field that can be generated by existent magnetic heads (for example, about 10 kOe) is applied.

To address the problem as described above, a thermally assisted magnetic recording system has attracted attention. The thermally assisted magnetic recording system is a technique that records magnetic signals by applying an external magnetic field in the state where the switching field is lowered only for a locally heated portion by irradiating the magnetic recording medium with laser light as propagating light or near field light, and reproduces the recorded magnetic signals by a magnetoresistive device, etc. The thermally assisted magnetic recording system is referred to as an optically assisted magnetic recording since light is used for heating, or also as a hybrid recording since this is a combined technique of magnetism and light. Hereinafter, the thermally assisted magnetic recording shall be used in the present specification.

In the thermally assisted magnetic recording system, since the magnetic recording medium is heated locally during recording and the anisotropy field is decreased locally to lower the switching field even when the anisotropy field of the magnetic recording medium at a normal temperature is high, magnetic signals can be recorded at a magnetic field that can be generated by the magnetic head. Accordingly, the use of the thermally assisted magnetic recording system allows a material having a high anisotropy field to be used for the magnetic recording medium, thereby being responsible for the demand for further increase in the recording density of the magnetic recording medium.

### SUMMARY OF THE INVENTION

In general, when magnetic signals are recorded on a magnetic recording medium by using a thermally assisted magnetic recording system, the magnetic recording medium is locally heated to a temperature near the Curie point (temperature at which a ferromagnetic material loses spontaneous magnetization and does not exhibits ferromagnetic behaviors). Accordingly, for the magnetic recording medium in the thermally assisted magnetic recording system, the Curie point is an extremely important physical property value and it is necessary to use a material having an appropriate Curie point for its magnetic recording layer.

For example, when the Curie point is excessively high, the magnetic recording medium will be damaged by the temperature elevation to a temperature near the Curie point. Further, the temperature elevation per se to a temperature near the Curie point will be impossible if a heating mechanism is used that can be mounted to a magnetic head of a magnetic recording device. Damage from which the magnetic recording medium will suffer includes, for example, deformation or melting of a substrate that constitutes the magnetic recording medium, delamination or irreversible change of a microstructure in each of the layers constituting the magnetic recording medium, evaporation of a lubricant, etc. Generally, when the temperature is taken into consideration at which the damage caused in the magnetic recording media become conspicuous, it is preferred to use a material having a Curie point of about 400° C. or lower as the magnetic recording layer for the magnetic recording medium in the thermally assisted magnetic recording system.

Further, in the thermally assisted magnetic recording system, a region adjacent to the local region of a magnetic recording layer intended for recording magnetic signals is also heated somewhat during recording of magnetic signals. Such a heating possibly cause overwriting (so-called, encroachment) of magnetic signals in the adjacent regions where the magnetic signals have already been recorded, or elimination of the magnetic signals caused by promoting thermal fluctuation of the magnetic signals in the adjacent region. Further, just after the recording of the magnetic signals is made, since the magnetic recording layer is kept heated somewhat even at a time the magnetic field from the magnetic head is removed, the thermal fluctuation is also promoted, with the result that the once recorded magnetic signals may be eliminated instantly. When the Curie point is excessively low, since the anisotropy field or the switching field changes remarkably even near the normal temperature, such problems will be posed. For solution of the problems described above, it is necessary that the magnetic recording layer have high anisotropy field or switching field near the normal temperature and it is necessary that the Curie point be at a somewhat high temperature. Generally, when the time required for recording magnetic signals, and specific heat or heat capacity, etc. of the magnetic recording layer are taken into consideration, it is preferred to use a material having a Curie point of about 200° C. or higher for the magnetic recording layer of the magnetic recording medium in the thermally assisted magnetic recording system. In view of the above, it is particularly preferred to use a material having a Curie point of about 200° C. or higher and 400° C. or lower for the magnetic recording layer of the magnetic recording medium in the thermally assisted magnetic recording system.

The Curie point of Co—Pt alloys in which the atom content is substantially equal between Co and Pt is reported to be a value of about 600° C. to 700° C. Accordingly, when a Co—Pt alloy in which the atom content is substantially equal between Co and Pt is used as the material for the magnetic recording layer, since the anisotropy field is high, a magnetic recording medium excellent in the thermal stability of recorded magnetic signals can be manufactured. However, recording is impossible by the magnetic field that can be generated from existent magnetic heads and, further, since the Curie point is high, recording by the thermally assisted magnetic recording system is also impossible.

The present invention has been made in view of the problems described above, and intends to provide a magnetic recording medium having thermal stability of recorded magnetic signals and a writability based on the thermally assisted magnetic recording system by applying a ferromagnetic material having an anisotropy field at a normal temperature of 50 kOe or more and a Curie point of 200° C. or higher and 400° C. or lower to the recording layer.

To attain the purpose described above, the present inventors have made earnest studies based on the Co—Pt alloy described above and has found that a ferromagnetic material having a high anisotropy field and a Curie point which is appropriate as a magnetic recording layer of a thermally assisted magnetic recording medium together can be obtained by a Co—Ni—Pt alloy in which in which the atom content of Co and Ni is substantially equal to that of Pt and which has a high anisotropy field in the same manner as that in the Co—Pt alloy in which the atom content is substantially equal between Co and Pt.

The Curie point is generally a composition-sensitive physical property but a relation between the composition of the Co—Ni—Pt alloy and the Curie point has not yet been apparent so far. The present inventors have revealed a compositional region of Co—Ni—Pt alloys having an anisotropy field at a normal temperature of 50 kOe or more and a Curie point of 200° C. or higher and 400° C. or lower, thereby finding a ferromagnetic material necessary for manufacturing a magnetic recording medium having a thermal stability of recorded magnetic signals and a writability by the thermally assisted magnetic recording system.

That is, the invention intends to solve the problems described above by the following means.

(1) A magnetic recording medium which records a magnetic signal by applying an external magnetic field to the recording medium with the recording medium locally heated, in which

the magnetic recording layer for recording magnetic signals contains ferromagnetic crystal grains of a Co—Ni—Pt alloy with a Pt content of 44 at % or more and 55 at % or less, and an atom content ratio: Ni/(Co+Ni) of 0.64 or more and 0.8 or less.

(2) In the magnetic recording medium in (1) described above, the Curie point of the Co—Ni—Pt alloy is 200° C. or higher and 400° C. or lower.

(3) In the magnetic recording medium of (1) or (2) described above, the anisotropy field at a normal temperature of the Co—Ni—Pt alloy is 50 kOe or more.

The magnetic recording medium according to the invention is extremely excellent in the thermal stability of recorded magnetic signals since the Co—Ni—Pt alloy constituting the magnetic recording layer has a high anisotropy field at a normal temperature. Further, the magnetic recording medium according to the invention can record magnetic signals based on the thermally assisted magnetic recording system since the Co—Ni—Pt alloy constituting the magnetic recording layer has a Curie point in an appropriate temperature range.

That is, according to the invention, a magnetic recording medium at a high recording density having a thermal stability of recorded magnetic signals and a writability by the thermally assisted magnetic recording system together can be manufactured.

### BRIEF DESCRIPTION OF THE DRAWINGS

FIG. 1 is a schematic cross sectional view showing an example of a lamination configuration of a magnetic recording medium according to the present invention;

FIG. 2 is a graph showing an example of a relation between the temperature and the saturation magnetization in a magnetic recording medium of Example 1;

FIG. 3 is a graph showing a relation between the Curie point and the atom content ratio: Ni/(Co+Ni) of the magnetic recording layer in the magnetic recording medium of Example 1;

FIG. 4 is a graph showing a relation between the anisotropy field and the atom content ratio: Ni/(Co+Ni) of the magnetic recording layer in the magnetic recording medium of Example 1;

FIG. 5 is a graph showing a relation between the anisotropy field and the Pt content of the magnetic recording layer of the magnetic recording medium of Example 1; and

FIG. 6 is a table showing the composition, the Curie point, and the anisotropy field at a normal temperature of magnetic recording layer and the signal-to-noise ratio of magnetic signals recorded by the thermally assisted recording system, for the magnetic recording medium of Example 1.

### PREFERRED EMBODIMENTS OF THE INVENTION

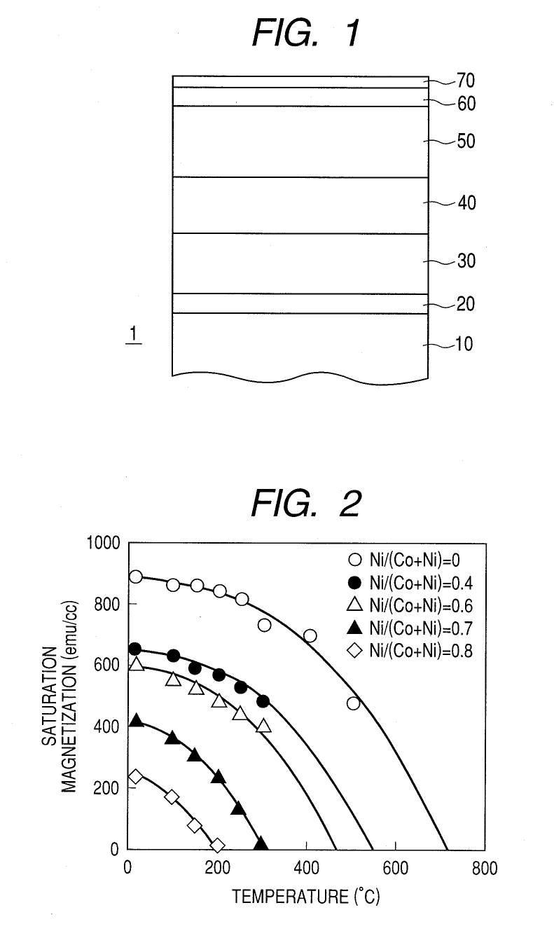

A magnetic recording medium 1 according to this embodiment is a disk-shaped magnetic recording medium and, as shown in FIG. 1, an adhesion layer 20, an intermediate layer 30, an orientation control layer 40, and a magnetic recording layer 50 are deposited in this order above a substrate 10. The upper surface of the magnetic recording layer 50 is covered with an overcoat 60, and a lubricant 70 is coated to the upper surface of the overcoat 60. However, the invention is not limited to this embodiment but a soft magnetic underlayer, a heat sink layer, etc. made of other materials can be additionally deposited for use to optional interlayer positions of the magnetic recording medium 1.

The substrate 10 is made of glass material. As a material for the substrate, non-magnetic materials of high rigidity, for example, Al, Al₂O₃, MgO, Si, etc. may also be used. The material for the adhesion layer 20 is, for example, Ta, Ti, or an alloy containing such elements, and the material for the intermediate layer 30 and the orientation control layer 40 is, for example, Cr, Ni, Pt, Ru, or alloys containing such elements.

The magnetic recording layer 50 contains ferromagnetic crystal grains of a Co—Ni—Pt alloy having the Pt content of 44 at % or more and 55 at % or less and the atom content ratio: Ni/(Co+Ni) of 0.64 or more and 0.8 or less. The magnetic recording layer 50 may be composed only of the ferromagnetic crystal grains of the Co—Ni—Pt alloy, or may also have a structure in which oxides such as SiO₂, TiO₂, Ta₂O₅, MgO, etc. or non-metal elements such as C, B, etc. are segregated to the grain boundary of the ferromagnetic crystal grains of the Co—Ni—Pt alloy.

The material for the overcoat 60 is, for example, diamond-like carbon, carbon nitride, silicon nitride, etc. The material for the lubricant 70 is, for example, perfluoropolyether, fluoroalcohol, fluorocarboxylic acid, etc.

Preferred embodiments of the invention will be described specifically with reference to examples. The following examples are merely illustration for easy understanding of the invention and do not restrict the invention unless otherwise specified.

### Example 1

A substrate 10 comprising borosilicate glass was provided. Above the substrate 10 were deposited a Ta layer by 5 nm as the adhesion layer 20, a Pt layer by 10 nm as the intermediate layer 30, an Ru layer by 20 nm as the orientation control layer 40, a Co—Ni—Pt alloy layer by 10 nm as the magnetic recording layer 50 in which the composition was changed variously, and a carbon nitride layer by 4 nm as the overcoat 60 in this order by a sputtering method, to manufacture a plurality of magnetic recording media in which the materials of the magnetic recording layers were different from each other. In the composition of the Co—Ni—Pt alloy layer, the Pt content was fixed to 50 at % and the atom content ratio between Co and Ni was changed variously.

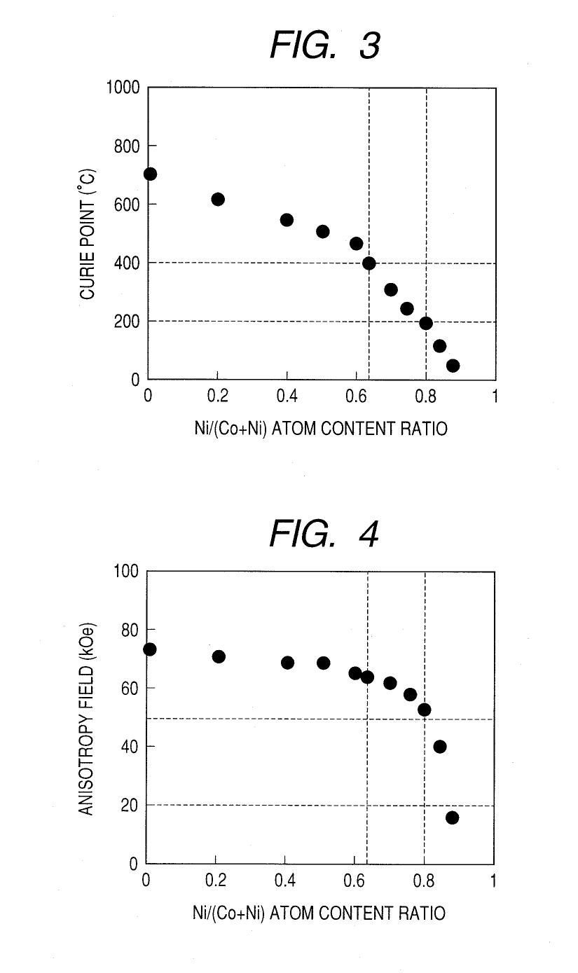

The saturation magnetization of the magnetic recording media was measured at various temperatures in a range from a normal temperature to 600° C. by using a vibrating sample magnetometer having a heating mechanism attached thereto. FIG. 2 shows examples of a relation between the thus obtained saturation magnetization and temperature. FIG. 3 shows Curie points of the magnetic recording media determined by fitting the relation between the saturation magnetization and the temperature according to Brillouin function as temperatures at which the saturation magnetization was reduced to 0. As shown in FIG. 3, the Curie point was 200° C. or higher and 400° C. or lower when the atom content ratio: Ni/(Co+Ni) in the Co—Ni—Pt alloy layer was 0.64 or more and 0.8 or less.

Then, the anisotropy fields at normal temperature of the magnetic recording media were measured by using a vibrating sample magnetometer and an anomalous Hall effect measurement apparatus. Referring to FIG. 4, the anisotropy field was lowered along with increase of the atom content ratio: Ni/(Co+Ni) and, when the atom content ratio: Ni/(Co+Ni) is 0.8 or less, the value for the anisotropy field was 50 kOe or more. In contrast, when the atom content ratio: Ni/(Co+Ni) exceeded 0.8, the value for the anisotropy field was decreased remarkably to less than 50 kOe. That is, it was found that the value of the anisotropy field at the normal temperature was remarkably lowered to less than 50 kOe when the atom content ratio: Ni/(Co+Ni) exceeded 0.8 and the Curie point was lowered to lower than 200° C.

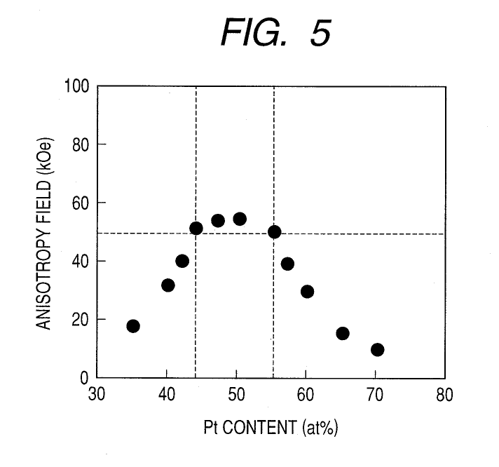

Then, in the composition of the Co—Ni—Pt alloy layer of the magnetic recording media, the Pt content was changed variously with the atom content ratio: Ni/(Co+Ni) fixed to 0.8. The anisotropy field at the normal temperature of the magnetic recording media was measured by the same method as described above. Referring to FIG. 5, the value for the anisotropy field reached the maximum value when the Pt content in the Co—Ni—Pt alloy layer was about 50 at %, whereas the value for the anisotropy field was 50 kOe or more when the Pt content was 44 at % or more and 55 at % or less. In contrast, the value of the anisotropy field was decreased remarkably to less than 50 kOe when the Pt content was less than 44 at %. In the same manner, the value of the anisotropy field was decreased remarkably to less than 50 kOe when the Pt content exceeded 55 at %.

As has been described above with reference to FIG. 4, when the Pt content is constant in the Co—Ni—Pt alloy layer, the anisotropy field lowers monotonously along with increase of the atom content ratio: Ni/(Co+Ni). Accordingly, a Co—Ni—Pt alloy layer having the Pt content of 44 at % or more and 55 at % or less has an anisotropy field of 50 kOe or more providing that the atom content ratio: Ni/(Co+Ni) is 0.8 or less.

Then, in the composition of the Co—Ni—Pt alloy layer of the magnetic recording media, the Pt content was changed variously within a range of 44 at % or more and 55 at % or less, and the atom content ratio: Ni/(Co+Ni) was changed variously within a range of 0.64 or more and 0.8 or less. When the Curie points of the magnetic recording media were determined by the same method as described above, the Curie point of each of the magnetic recording media was 200° C. or higher and 400° C. or lower.

### Test Example 1

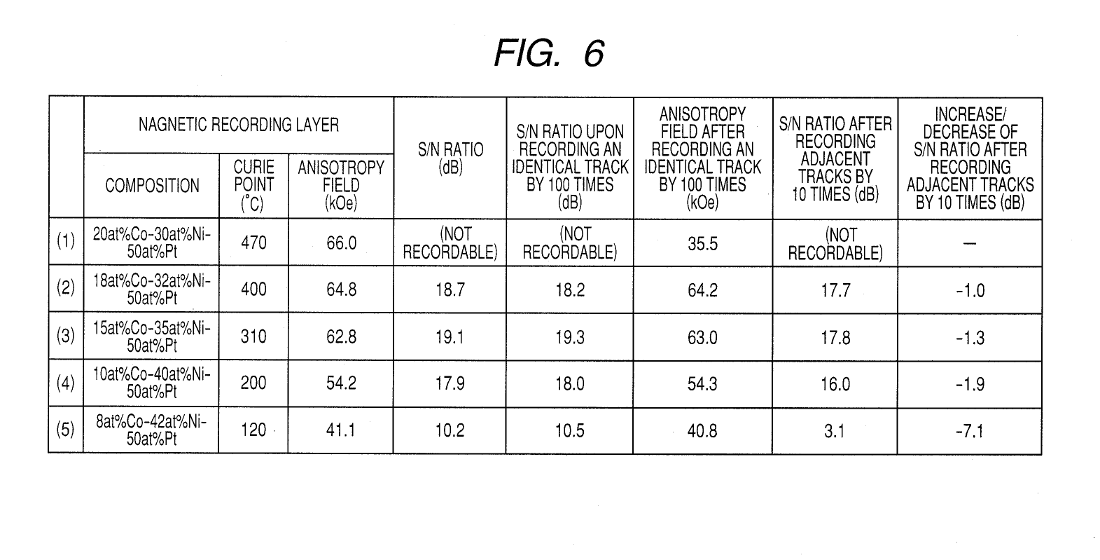

A plurality of magnetic recording media were manufactured by the same method as in Example 1 except that the composition of the Co—Ni—Pt alloy layer serving as the magnetic recording layer was different. FIG. 6 shows compositions of Co—Ni—Pt alloy layer as the magnetic recording layers of magnetic recording media, and Curie points and anisotropy fields measured by the same method as in Example 1. Magnetic signals were recorded on and reproduced from the magnetic recording media based on the thermally assisted magnetic recording system. A static read-write tester was used for the read-write experiment. This static read-write tester is such that magnetic head is moved above a static magnetic recording medium and magnetic signals are recorded/reproduced at a predetermined position. The magnetic head is provided with an optical pickup for an optical disk in addition to a magnetic pole and coils provided usually for generating magnetic fields, and can record magnetic signals by applying a magnetic field while elevating temperature in a local region of a magnetic recording medium by a laser. Further, the magnetic head is provided with a tunneling magnetoresistive device and can reproduce magnetic signals recorded on the magnetic recording medium.

Magnetic signals with a bit length of 100 nm and a track width of 800 nm were recorded on the magnetic recording media shown in FIG. 6. These magnetic signals were recorded by controlling laser irradiation time, moving speed of the magnetic head, polarity reversal frequency of the magnetic field to be applied, etc. In this case, the laser emission intensities were set in accordance with the Curie points respectively such that the temperature of the magnetic recording medium was elevated up to the vicinity of the Curie point during recording, and the strength of the recording magnetic field to be applied was made constant. FIG. 6 shows the signal-to-noise ratio obtained by reproducing the thus recorded magnetic signals.

In each of the magnetic recording media (2) to (4) in FIG. 6 having Curie points of 200° C. or higher and 400° C. or lower, a magnetic signal could be recorded and reproduced and a good signal-to-noise ratio was obtained. By contrast, in the magnetic recording medium (5) in FIG. 6 having a Curie point of 200° C. or lower, while the magnetic signal could be recorded and reproduced, the signal-to-noise ratio was remarkably lower than those of the magnetic recording media (2) to (4) in FIG. 6 because of encroachment and thermal fluctuation during recording for adjacent bits. Further, in the magnetic recording medium (1) in FIG. 6 having a Curie point of 470° C., a magnetic signal could not be recorded even when the temperature was elevated to the vicinity of the Curie point. When the surface for the laser irradiated portion of the magnetic recording medium (1) in FIG. 6 was observed by using an atomic force microscope after the temperature is lowered to the normal temperature, each of the layers constituting the magnetic recording medium was delaminated from the substrate. That is, it was found that the magnetic recording medium (1) in FIG. 6 had been damaged when the temperature was elevated up to the vicinity of the Curie point since the Curie point is excessively high.

### Test Example 2

A plurality of magnetic recording media were manufactured by the same method as in the Test Example 1. After recording of magnetic signals was repetitively performed by 100 times to an identical track of each of the magnetic recording media shown in FIG. 6 based on the thermally assisted magnetic recording system by the same method as in the test example 1, the magnetic signal of each of the tracks was reproduced. FIG. 6 shows the thus obtained signal-to-noise ratios.

In the magnetic recording media (2) to (4) in FIG. 6 having Curie points of 200° C. or higher and 400° C. or lower, good signal-to-noise ratios were obtained as in the Test Example 1. The magnetic signal could be recorded and reproduced for each of the magnetic recording media (2) to (4). By contrast, in the magnetic recording medium (5) in FIG. 6 having a Curie point of 200° C. or lower, the signal-to-noise ratio thereof was remarkably lower than those of the magnetic recording media (2) to (4) in FIG. 6 as in the Test Example 1.

### Test Example 3

A plurality of magnetic recording media were manufactured by the same method as in the Test Example 1. Recording of magnetic signals was repetitively performed by 100 times to an identical track of each of the magnetic recording media shown in FIG. 6 based on the thermally assisted magnetic recording system by the same method as in the test example 1. Subsequently, the anisotropy field of the region including the track was measured by the same method as in Example 1. FIG. 6 shows the values of the thus obtained anisotropy fields.

In the magnetic recording media (2) to (5) in FIG. 6 having Curie points of 400° C. or lower, the values for the anisotropy fields were identical with those before recording of the magnetic signals even after recording of the magnetic signals had been repetitively performed by 100 times to an identical track based on the thermally assisted magnetic recording system. That is, these magnetic recording media exhibited values of the anisotropy field unchanged even when temperature was elevated and lowered repetitively by 100 times between the normal temperature and the Curie point.

By contrast, in the magnetic recording medium (1) in FIG. 6 having a Curie point of 400° C. or higher, when temperature was elevated and lowered repetitively by 100 times between the normal temperature and the Curie point, the value of the anisotropy field was lowered remarkably. The microstructure of the magnetic recording medium (1) was observed by a transmission electron microscope. As a result, each of the layers constituting the magnetic recording medium was diffused and mixed to each other in the region and the vicinity of the region that was subjected to temperature elevation and lowering. That is, it was found that since the Curie point was excessively high for the magnetic recording medium (1) in FIG. 6, the medium was damaged violently if temperature elevation and lowering were repeated between the normal temperature and the Curie point.

### Test Example 4

A plurality of magnetic recording media were manufactured in the same method as in the Test Example 1. Magnetic signals were recorded on the magnetic recording media shown in FIG. 6 based on the thermally assisted magnetic recording system and the recorded magnetic signals were reproduced by the same method as in the Test Example 1 to obtain signal-to-noise ratios. Subsequently, magnetic signals were repetitively recorded by 10 times to tracks adjacent to the track recorded as described above by the same method, and the magnetic signals on the track initially recorded with magnetic signals were reproduced again. FIG. 6 shows increase/decrease of the signal-to-noise ratio obtained when the signal-to-noise ratio obtained as described above is compared with the signal-to-noise ratio obtained before recording onto the adjacent tracks.

In the magnetic recording media (2) to (4) in FIG. 6 having Curie points of 200° C. or higher and 400° C. or lower, the signal-to-noise ratios were lowered owing to the recording onto the adjacent tracks in comparison with the signal-to-noise ratios before the recording onto the adjacent tracks. However, the lowering was slight and good signal-to-noise ratios were obtained even after the recording onto the adjacent tracks. In contrast, for the magnetic recording medium (5) in FIG. 6 having a Curie point of 200° C. or lower, the signal-to-noise ratio was lowered remarkably in comparison with the signal-to-noise ratio before recording onto the adjacent tracks because of encroachment and promotion of thermal fluctuation during the recording onto the adjacent tracks.

The present invention is applicable for a magnetic recording medium suitable for the thermally assisted magnetic recording system for recording magnetic signals by applying an external magnetic field while locally heating the recording medium.

What is claimed is:

1. A magnetic recording medium which records a magnetic signal by applying an external magnetic field to the recording medium with the recording medium locally heated, in which
a magnetic recording layer for recording magnetic signals contains ferromagnetic crystal grains of a Co—Ni—Pt alloy with a Pt content of 44 at % or more and 55 at % or less, and with an atom content ratio: Ni/(Co+Ni) of 0.64 or more and 0.8 or less.

2. The magnetic recording medium according to claim 1, wherein the Curie point of the Co—Ni—Pt alloy is 200° C. or higher and 400° C. or lower.

3. The magnetic recording medium according to claim 1, wherein the anisotropy field of the Co—Ni—Pt alloy is 50 kOe or more.

4. A magnetic recording medium having an adhesion layer, an intermediate layer, an orientation control layer, and a magnetic recording layer above a substrate, the magnetic recording medium recording a magnetic signal by applying an external magnetic field to the magnetic recording layer with the magnetic recording layer locally heated, in which
the magnetic recording layer contains ferromagnetic crystal grains of a Co—Ni—Pt alloy with a Pt content of 44 at % or more and 55 at % or less, and with an atom content ratio: Ni/(Co+Ni) of 0.64 or more and 0.8 or less.

5. The magnetic recording medium according to claim 4, wherein the Curie point of the Co—Ni—Pt alloy is 200° C. or higher and 400° C. or lower.

6. The magnetic recording medium according to claim 4, wherein the anisotropy field of the Co—Ni—Pt alloy is 50 kOe or more.

7. The magnetic recording medium according to claim 4, wherein the substrate comprises a material selected from the group consisting of glass, Al, Al₂O₃, MgO and Si, the adhesion layer comprises Ta or Ti or an alloy containing these elements, and the intermediate layer and the orientation control layer each comprise one element selected from Cr, Ni, Pt, and Ru, or an alloy containing these elements.

8. A magnetic recording medium which records a magnetic signal by applying an external magnetic field to the recording medium with the recording medium locally heated, in which
a magnetic recording layer for recording magnetic signals contains ferromagnetic crystal grains of a Co—Ni—Pt alloy having a Curie point of 200° C. or higher and 400° C. or lower and having an anisotropy field of 50 kOe or more.

9. The magnetic recording medium according to claim 2, wherein the anisotropy field of the Co—Ni—Pt alloy is 50 kOe or more.

10. The magnetic recording medium according to claim 5, wherein the anisotropy field of the Co—Ni—Pt alloy is 50 kOe or more.

11. The magnetic recording medium according to claim 1, wherein said magnetic recording layer has a structure in which oxides such as SiO₂, TiO₂, Ta₂O₅, MgO or non-metal elements such as C, B are segregated to the grain boundary of the ferromagnetic crystal grains of the Co—Ni—Pt alloy.

12. The magnetic recording medium according to claim 4, wherein said magnetic recording layer has a structure in which oxides such as SiO₂, TiO₂, Ta₂O₅, MgO or non-metal elements such as C, B are segregated to the grain boundary of the ferromagnetic crystal grains of the Co—Ni—Pt alloy.

13. The magnetic recording medium according to claim 8, wherein said magnetic recording layer has a structure in which oxides such as SiO₂, TiO₂, Ta₂O₅, MgO or non-metal elements such as C, B are segregated to the grain boundary of the ferromagnetic crystal grains of the Co—Ni—Pt alloy.
